(19) United States
(12) Patent Application Publication
(10) Pub. No.: US 2015/0227735 A1
(43) Pub. Date: Aug. 13, 2015

(54) SYSTEM AND METHOD FOR EYE TRACKING AUTHENTICATION

(71) Applicant: ROBERT CHAPPELL, Mesa, AZ (US)

(72) Inventor: ROBERT CHAPPELL, Mesa, AZ (US)

(21) Appl. No.: 14/622,800

(22) Filed: Feb. 13, 2015

Related U.S. Application Data
(60) Provisional application No. 61/939,670, filed on Feb. 13, 2014.

(51) Int. Cl. G06F 21/32; G06F 3/01

(52) U.S. Cl. CPC G06F 21/32; G06F 3/013

(57) ABSTRACT

The present invention comprises a combination of an eye tracking capable camera module coupled with one or more targets displayed on a screen. The most preferred embodiments of the present invention will track eye movement relative to the position of the targets displayed on the screen and authenticate a user based on a pre-determined visual movement pattern of the user's eye and the targets displayed on the screen. The pre-determined movement pattern may include eye movement patterns including directional movement, dwell time, delays, and other similar variations. Additionally, a method for authenticating a user by implementing a system that is capable of tracking and recording a user's eye movements is also disclosed.

### BACKGROUND OF THE INVENTION

1. Technical Field

The present invention relates generally to technology and more specifically relates to technology used to track eye movement.

2. Background Art

Eye tracking is the process of measuring either the point of gaze (where one is looking) or the motion of an eye relative to the head. An eye tracker is a device for measuring eye positions and eye movement. Eye trackers are used in research on the visual system, in psychology, in cognitive linguistics and in product design. There are a number of methods for measuring eye movement. The most popular variant uses video images from which the eye position is extracted. Other methods use search coils or are based on the electrooculogram.

Eye tracking data is collected using either a remote or head-mounted ‘eye tracker’ connected to a computer. While there are many different types of non-intrusive eye trackers, they generally include two common components: a light source and a camera. The light source (usually infrared) is directed toward the eye. The camera tracks the reflection of the light source along with visible ocular features such as the pupil. This data is used to extrapolate the rotation of the eye and ultimately the direction of gaze. In addition to basic eye position information, other measurements such as blink frequency and changes in the size of the pupil may also be detected by the eye tracker. The aggregated data is typically written to a computerized data file where the data can be analyzed and used for various purposes.

In recent years, the increased sophistication and accessibility of eye tracking technologies have generated a great deal of interest in the commercial sector. Applications include web usability, advertising, sponsorship, package design and automotive engineering. In general, commercial eye tracking applications function by presenting a target stimulus to a sample of consumers while an eye tracker is used to record the activity of the eye.

Examples of target stimuli may include websites, television programs, sporting events, films, commercials, magazines, newspapers, packages, shelf Displays, consumer systems (ATMs, checkout systems, kiosks), and software. The resulting data can be statistically analyzed and graphically rendered to provide evidence of specific visual patterns. By examining fixations, saccades, pupil dilation, blinks and a variety of other behaviors researchers can determine a great deal about the effectiveness of a given medium or product. While some companies complete this type of research internally, there are many private companies that offer eye tracking services and analysis.

One rapidly growing field for eye tracking applications is web usability. While traditional usability techniques are often quite powerful in providing information on clicking and scrolling patterns, eye tracking offers the ability to analyze user interaction between the clicks and how much time a user spends between clicks. This data can provide valuable insight into which features are the most eye-catching, which features cause confusion and which ones are ignored altogether. Specifically, eye tracking can be used to assess search efficiency, branding, online advertisements, navigation usability, overall design and many other site components. Analyses may target a prototype or competitor site in addition to the main client site.

Eye tracking is also commonly used in a variety of different advertising media. Commercials, print ads, online ads and sponsored programs are all conducive to analysis with current eye tracking technology. For instance in newspapers, eye tracking studies can be used to find out in what way advertisements should be mixed with the news in order to catch the subject's eyes. Analyses focus on visibility of a target product or logo in the context of a magazine, newspaper, website, or televised event. This allows researchers to assess in great detail how often a sample of consumers fixates on the target logo, product or ad. In this way, an advertiser can quantify the success of a given campaign in terms of actual visual attention. Another example of this is a study that found that in a search engine results page authorship snippets received more attention than the paid ads or even the first organic result.

Eye tracking is also commonly used in communication systems for disabled persons: allowing the user to speak, send e-mail, browse the Internet and perform other such activities, using only their eyes. Eye control works even when the user has involuntary movement as a result of various muscular disorders or other disabilities, and for those who have glasses or other physical interference which would limit the effectiveness of older eye control systems. Many computers are now offered with optional eye tracking software and hardware that allows the user to control the computer with eye movement.

While the technology associated with eye tracking has evolved over the years, there are additional applications for eye tracking technology that may be advanced. Accordingly, without additional improvements in the state of the art for the implementation of eye tracking capabilities for computers and other screen-based devices, the growth and development of eye tracking applications will continue to be suboptimal.

### BRIEF SUMMARY OF THE INVENTION

The present invention comprises a combination of an eye tracking capable camera module coupled with one or more targets displayed on a screen. The most preferred embodiments of the present invention will track eye movement relative to the position of the targets displayed on the screen and authenticate a user based on a pre-determined visual movement pattern of the user's eye and the targets displayed on the screen. The pre-determined movement pattern may include eye movement patterns including directional movement, dwell time, delays, and other similar variations. Additionally, a method for authenticating a user by implementing a system that is capable of tracking and recording a user's eye movements is also disclosed.

### BRIEF DESCRIPTION OF THE FIGURES

The preferred embodiments of the present invention will hereinafter be described in conjunction with the appended drawings, wherein like designations denote like elements, and:

FIG. 1 is a schematic diagram of a rotatable display screen positioned in a first position suitable for use in conjunction with an eye tracking system in accordance with a preferred exemplary embodiment of the present invention;

FIG. 2 is a flow chart for a method of eye tracking in accordance with a preferred exemplary embodiment of the present invention;

FIG. 3 is a block diagram of several eye movement tracking variables suitable for use with a eye tracking system in accordance with a preferred exemplary embodiment of the present invention; and

FIG. 4 is a schematic diagram of a target with variable accuracy functionality suitable for use with an eye tracking system in accordance with a preferred exemplary embodiment of the present invention.

### DETAILED DESCRIPTION

The present invention comprises a combination of an eye tracking capable camera module coupled with one or more targets displayed on a screen. The most preferred embodiments of the present invention will track eye movement relative to the position of the targets displayed on the screen and authenticate a user based on a pre-determined visual movement pattern of the user's eye and the targets displayed on the screen. The pre-determined movement pattern may include eye movement patterns including directional movement, dwell time, delays, and other similar variations. Additionally, a method for authenticating a user by implementing a system that is capable of tracking and recording a user's eye movements is also disclosed.

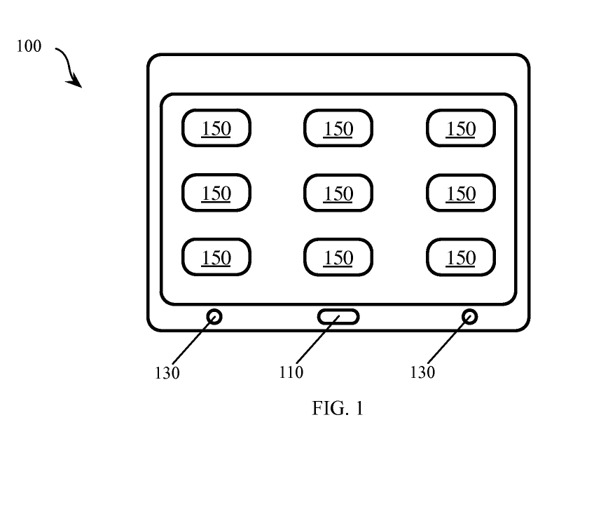

Referring now to FIG. 1, a schematic diagram of a display screen 100 positioned in suitable for use in conjunction with an eye tracking system in accordance with a preferred exemplary embodiment of the present invention is depicted. For purposes of this disclosure, display screen 100 is any type of display screen, including but not limited to computer screens, tablet screens, smart phone screens, etc. As shown in FIG. 1, screen 100 comprises a camera module 110 and one or more optional IR illuminators 130. With camera module 110 in this position, camera module 110 is positioned and configured to capture eye tracking images using IR light signals and will block visible light signals.

As shown in FIG. 1, screen 100 will display a plurality of targets 150. Targets 150 may be any type of visual image or icon that is recognizable by the eye. For example, letters, numbers, symbols, pictograms, logos, etc. are all capable of being used as targets 150.

The user will view the targets and train his or her gaze on the targets in a pre-determined sequence. Camera module 110 will capture and record the gazing pattern of the user's eyes as they view screen 100 and targets 150. The correct gazing pattern sequence will be associated with secure access to a computer or a computer application. By correctly gazing on the targets in the correct sequence, the user will be provided with access to the computer or the computer application associated with the target sequence. Different sequences may be used to grant different levels of access to multiple users using the same computer where each user will have a unique sequence associated with their user account and they will have access to the applications associated with their account, provided that their gazing pattern is approved.

In certain preferred embodiments, there may be a timing element introduced into the gazing sequence as well. In this embodiment, the user must not only gaze at the targets 150 in the correct sequence, but must also gaze at a specific target 150 for a specific period of time. Additionally, the user may be given multiple opportunities to try and perform the correct gazing sequence prior to be locked out of the system.

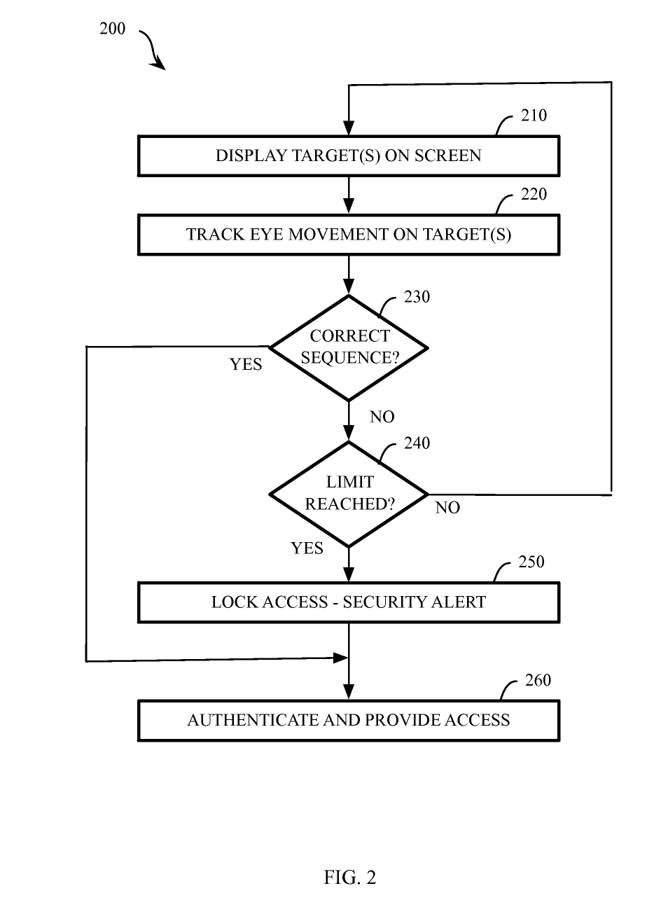

Referring now to FIG. 2, a flow chart for a method of eye tracking authentication in accordance with a preferred exemplary embodiment of the present invention is depicted. As shown in FIG. 2, a plurality of targets will be displayed on a screen (step 210). It should be noted the “targets” on the screen may take the form of pictures, graphic images, textual images, etc. and the word “target” should be broadly construed.

The screen may be any type of screen, including a computer screen, a tablet, a smart phone, etc. so long as it is capable of receiving data from an eye-tracking camera (e.g., internal or external cameras). In the most preferred embodiments of the present invention, the eye-tracking camera will track the movement of the user's eyes as the user gazes at the targets (step 220). If the user looks at the targets in the correct sequence (step 230=“YES”), the user will be authenticated and provided access to device or application associated with the gazing pattern (step 260).

However, if the gazing sequence is incorrect (step 230=“NO”), then the system will check to determine if the limit of attempts has been reached (step (240). If the limit has been reached (step 240=“YES”), then the user access will be denied and a security alert may be logged or security alert sent to the appropriate person(s). If the limit has not been reached (step 240=“NO”), then the user will be provided with another attempt (step 210).

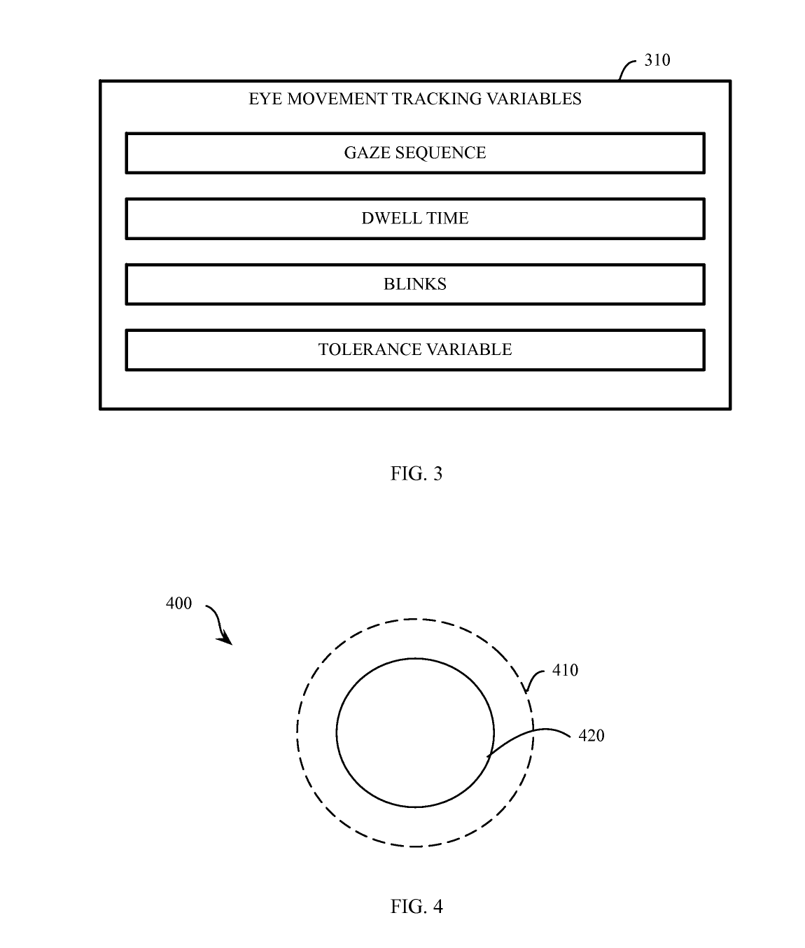

Referring now to FIG. 3, a block diagram of several eye movement tracking variables suitable for use with an eye tracking system in accordance with a preferred exemplary embodiment of the present invention is depicted.

As shown in FIG. 3, there are a number of variables that can be employed in the user authentication process. For example, the gaze sequence can be a programmatic series of targets that must be viewed in the proper order. Any gaze sequence that does not follow the pre-determined sequence could be used to prevent access to the functions protected by the various embodiments of the present invention. Similarly, any gaze sequence that includes a non-sequence target could be used to prevent access to the functions protected by the various embodiments of the present invention.

In order to further qualify a user for access to the system, the gaze sequence may include the concept of “dwell time” for the target gaze sequence. In at least some preferred embodiments of the present invention, the amount of time that the user's gaze remains fixed on a target will be a pre-determined length of time. When performing user authentication, the system will calculate the actual gaze time and if the amount of actual gaze time is greater or less than the pre-determined gaze time, the system will prevent access to the functions protected by the various embodiments of the present invention.

In addition to a specific gaze sequence, at lease some preferred embodiments of the present invention may track and record the number and duration of eye blinks performed by a user's eye during the authentication sequence. In this manner, another authentication step may be included where the user has to blink a predetermined number of blinks while gazing at a specific target displayed to the user on the screen.

In order to provide for maximum flexibility for multiple application environments, each eye movement tracking variable may have a tolerance variable assigned to it. By increasing the magnitude of the tolerance variable, the specific eye movement tracking variable can be adjusted. If the tolerance variable were implemented as a sliding scale from 0-100, with 0 being the least amount of tolerance and 100 being the most amount of tolerance, the eye movement tracking variable can be adjusted from an exact requirement to a more forgiving measurement. For example, the tolerance variable for eye movement tracking may require a dwell time of 2 seconds on a specific target with the tolerance variable is set to 0. By adjusting the tolerance variable to 100, the amount of dwell time would be adjusted to accept any dwell time between 1-3 seconds.

Referring now to FIG. 4, a schematic diagram of a target 400 with variable target accuracy functionality suitable for use with an eye tracking system in accordance with a preferred exemplary embodiment of the present invention is depicted. In at least some preferred embodiments of the present invention, target 400 will have a visible target boundary 420 and a nominal target boundary 410. In some instances, visible target boundary 420 will occupy a smaller space on the display while nominal target boundary 420 will occupy a larger space on the display, with the nominal target boundary being invisible to the naked eye.

This provides for a more “forgiving” eye tracking application inasmuch as the user will get credit for looking at visual target 400 if the user's gaze is focused within the space defined by nominal target boundary 410, even if the user's gaze does not focus within the space defined by visual target boundary 420.

In other instances, visible target boundary 420 will occupy a larger space on the display while nominal target boundary 420 will occupy a smaller space on the display, with the nominal target boundary remaining invisible to the naked eye.

This provides for a less “forgiving” eye tracking application inasmuch as the user will only get credit for looking at visual target 400 if the user's gaze is focused within the space defined by nominal target boundary 410, even if the user's gaze does is focused within the space defined by visual target boundary 420. The use of both a visible target boundary 420 and a nominal target boundary 410 will allow the security system to be adapted for various environments where more strict or less strict security is desired for authenticating users of the system.

From the foregoing description, it should be appreciated that an effective and efficient for adapting a camera module for use in both eye tracking applications and standard photo/video images is provided by the various preferred embodiments of the present invention and that the various preferred embodiments offer significant benefits that would be apparent to one skilled in the art. Furthermore, while multiple preferred embodiments have been presented in the foregoing description, it should be appreciated that a vast number of variations in the embodiments exist.

Accordingly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A method of eye tracking authentication comprising:
displaying a plurality of targets on a screen to a user;
tracking a sequence of user eye movements of the user relative to the plurality of targets on the screen;
comparing the sequence of user eye movements to a predetermined sequence of eye movements;
denying access if sequence of user eye movements does not match the predetermined sequence of eye movements; and
granting access if the sequence of user eye movements matches the predetermined sequence of eye movements.

2. The method of claim 1 wherein at least one of the plurality of targets comprises a visible target boundary and a nominal target boundary.

3. The method of claim 1 wherein the visible target boundary defines a space on the screen that is larger than a space on the screen defined by the nominal target boundary.

4. The method of claim 1 wherein the visible target boundary defines a space on the screen that is smaller than a space on the screen defined by the nominal target boundary.

5. The method of claim 1 wherein the predetermined sequence of eye movements are defined, at least in part, by a plurality of eye movement tracking variables.

6. The method of claim 5 wherein the plurality of eye movement tracking variables comprises at least one of a predetermined gaze sequence, a predetermined dwell time, a predetermined number of blinks, and a tolerance variable.

7. The method of claim 5 wherein the plurality of eye movement tracking variables comprises a predetermined gaze sequence, a predetermined dwell time, a predetermined number of blinks, and a tolerance variable.

8. The method of claim 1 further comprising the steps of:
denying access to the user after the user fails to demonstrate a sequence of user eye movements that matches the predetermined sequence of eye movements more than some predetermined number of times; and
issuing a security alert.

9. The method of claim 1 wherein the predetermined sequence of eye movements comprises a plurality of predetermined sequence of eye movements, with each of the predetermined sequence of eye movements being used to authenticate a different user.

10. The method of claim 1 wherein the predetermined sequence of eye movements are defined, at least in part, by a plurality of eye movement tracking variables and wherein the predetermined sequence of eye movements comprises a plurality of predetermined sequence of eye movements, with each of the predetermined sequence of eye movements being used to authenticate a different user and further comprising the steps of:
denying access to the user after the user fails to demonstrate a sequence of user eye movements that matches the predetermined sequence of eye movements more than some predetermined number of times; and
issuing a security alert.

11. An eye tracking system comprising:
a screen, the screen displaying a plurality of targets to a user;
at least one eye tracking camera, wherein the at least one eye tracking camera:
tracks a sequence of user eye movements of the user relative to the plurality of targets on the screen and compares the sequence of user eye movements to a predetermined sequence of eye movements; and
denies access to at least one system function if sequence of user eye movements does not match the predetermined sequence of eye movements or grants access to the at least one system function if the sequence of user eye movements matches the predetermined sequence of eye movements.

12. The system of claim 11 wherein at least one of the plurality of targets comprises a visible target boundary and a nominal target boundary.

13. The system of claim 11 wherein the visible target boundary defines a space on the screen that is larger than a space on the screen defined by the nominal target boundary.

14. The system of claim 11 wherein the visible target boundary defines a space on the screen that is smaller than a space on the screen defined by the nominal target boundary.

15. The system of claim 11 wherein the predetermined sequence of eye movements are defined, at least in part, by a plurality of eye movement tracking variables.

16. The system of claim 15 wherein the plurality of eye movement tracking variables comprises at least one of a predetermined gaze sequence, a predetermined dwell time, a predetermined number of blinks, and a tolerance variable.

17. The system of claim 15 wherein the plurality of eye movement tracking variables comprises a predetermined gaze sequence, a predetermined dwell time, a predetermined number of blinks, and a tolerance variable.

18. The system of claim 11 wherein the system denies access to the user after the user fails to demonstrate a sequence of user eye movements that matches the predetermined sequence of eye movements more than some predetermined number of times and wherein the system issues a security alert.

19. The system of claim 11 wherein the predetermined sequence of eye movements comprises a plurality of predetermined sequence of eye movements, with each of the predetermined sequence of eye movements being used to authenticate a different user.

20. The system of claim 11 wherein the predetermined sequence of eye movements are defined, at least in part, by a plurality of eye movement tracking variables and wherein the predetermined sequence of eye movements comprises a plurality of predetermined sequence of eye movements, with each of the predetermined sequence of eye movements being used to authenticate a different user and wherein the system denies access to the user after the user fails to demonstrate a sequence of user eye movements that matches the predetermined sequence of eye movements more than some predetermined number of times and wherein the system issues a security alert.
